(19) United States
(12) Patent Application Publication
(10) Pub. No.: US 2011/0284472 A1
(43) Pub. Date: Nov. 24, 2011

(54) WATER REDUCTION FOR COOKING GREASE AND OIL COLLECTION

(76) Inventor: Thomas M. Pahl, Suamico, WI (US)

(21) Appl. No.: 13/102,036

(22) Filed: May 5, 2011

Related U.S. Application Data
(60) Provisional application No. 61/331,747, filed on May 5, 2010.

(51) Int. Cl. C02F 1/40; B01D 17/04; B01D 17/05; C02F 1/52

(52) U.S. Cl. 210/708; 210/241; 210/198.1; 210/767; 210/205

(57) ABSTRACT

A system and method of separating grease from water in used cooking oil prior to collection and removal of the grease from the restaurant or other facility where the used cooking oil was created, collected or stored.

### CROSS-REFERENCE TO RELATED APPLICATION

The present application claims priority to earlier filed U.S. Provisional Application Ser. No. 61/331,747, filed May 5, 2010, the disclosure of which is incorporated herein by reference in its entirety.

### BACKGROUND

The current process for restaurant cooking oil or grease trap collection is for a company to treat, suck, or pump it out into a tank truck. The material extracted from the cooking oil or grease trap at most restaurants is typically an oil/water mixture which is approximately 85-95% water. This mixture is conventionally transported back to central plant or municipality for processing. In the case of the treatment or rendering plant, in most cases the mixture will be heated up to assist in separation of the water and oil. Once heated, the mixture is allowed to sit for up to 24 hours. In the case of a municipality, they charge the company with the trap grease for processing the material in their system. This not only costs a lot of money for the company in surcharges, transportation, and energy, but plant throughput can also be limited by the amount of time it takes for separation.

If the company processes the material, the concentrated grease layer after separation (˜5-10% by volume) is then sent on for further processing which sometimes includes additional energy requirements like in an evaporator. The rag layer or whitewater makes up the largest volume which is then normally sent to a wastewater treatment system for further separation of the oil, solids, and water. This treatment can be equipment and chemically laborious, costing the company further in electrical energy and chemical costs. The effluent is monitored in many cases by a municipality, and the company is normally billed on a surcharge bases for Total Suspended Solids (TSS), flow, Biological Oxygen Demand (BOD), Chemical Oxygen Demand (COD), pH, and Fats, Oils and Greases (FOG) or some other fraction. The sludge that is removed can also be a financial burden, costing the company further dollars in haul-out or other sludge handling costs. Some companies are even charged a dumping fee for going on to land spread, a digester, a manure pit or some other kind of waste disposal method.

Improvements to the methods and devices for collecting cooking oil and grease for disposal are desirable.

### BRIEF DESCRIPTION OF THE DRAWINGS

The accompanying drawing figures, which are incorporated in and constitute a part of the description, illustrate several aspects of the invention and together with the description, serve to explain the principles of the invention. A brief description of the figures is as follows:

FIG. 1 is a schematic side view of a grease removal truck according to the present disclosure, with the truck including a first water and grease separate chamber and a second main grease collection chamber.

FIG. 2 is a schematic side view of a grease removal truck according to the present disclosure, with a single tank in the grease removal truck.

FIG. 3 is a side schematic view of a grease removal truck according to the present disclosure, with a single tank in the grease removal truck.

### DESCRIPTION

Reference will now be made in detail to exemplary aspects of the present invention which are illustrated in the accompanying drawings. Wherever possible, the same reference numbers will be used throughout the drawings to refer to the same or like parts.

The present disclosure is directed to the use of chemical and mechanical separation of grease and water from used cooking oil, either individually or in combination, prior to loading the grease into a grease removal truck or doing separation in the grease removal truck prior to the truck leaving the establishment where the used cooking oil was collected. Grease removal trucks are currently designed to remove material out of grease traps and other oil collection devices, such as might be found at restaurants, banquets halls, hotels, convention centers, etc. It is anticipated that the pre-processing apparatus would be mounted to or a part of the equipment of the grease removal truck, be a temporary device used during the removal or separation of the material, be an adjunct removal system process such as an intermediate tank/removal assembly, or be a system installed at the permanent site so that retro-fitting of facility where the used cooking oil is located would be simple or not be required at all. This would reduce overall costs of implementing the solution by allowing a single truck mounted or separate device unit to service a number of restaurants or suppliers, instead of each restaurant installing their own higher cost oil and grease separation system. By treating these and forcing the oil and/or grease separation in the truck or in the restaurant holding vessel, the restaurant traps or collection devices can then be back filled or left with clean, low COD/FOG water. The concentrated oil/water mixture in the truck is maintained with a much higher oil level giving the grease recovery company the following benefits:
Lower hauling cost
Lower manpower costs
Lower truck maintenance costs
Lower energy consumption at the plant in the initial separation process
Higher product yields
Lower energy costs in secondary separation
Lower wastewater costs—energy
Lower wastewater costs—flow
Lower wastewater costs—chemical
Lower sludge haul-out costs
Lower potential for city surcharges
   There are many ways this can be achieved and these are described briefly below. The examples illustrative in nature and are not intended to limit the scope of the present disclosure.
   1. Initial Separation with Chemical:

Chemicals can break the oil/water emulsion with or without the need for elevating the temperature of the material. This chemical separation may be done with one individual or dual liquid solids separation chemical, oil cracking with reduction in pH levels, or achieved with a multiple component program. Other suitable methods are also available are should be considered within the scope of the present disclosure.

A non-limiting example of an individual chemical such as a coagulant or individual combination chemical for liquid solids separation could be a dry or emulsion polymer. Such a treatment regime could also include a combination of coagulant and flocculent increase the floc size large enough to aid separation and minimize moisture content. If used inside the collection vehicle, the water separated from the oil and/or grease by action of the chemical may then be returned to a holding tank at the restaurant. This process may also be used within a restaurant's holding tank so that just the concentrated layer of grease and/or oil will be removed from the tank and pumped into the collection vehicle. Two or more separate tanks or holding vessels may be used, with a first vessel to contain the untreated oil/grease/water mixture prior to any chemicals being added, a second vessel to contain the treated mixture and the resulting de-watered grease and/or oil, and possibly a third vessel to hold the water extracted from the second vessel after treatment and separation. This combination of tanks or vessels may be at the restaurant, on the grease removal truck, or separated between the two.

The addition of pH lowering chemicals to the untreated oil/water mixture is another method for separating the materials. This approach may include the utilizing of an inorganic or organic acid in order to lower the pH to a level where separation of grease and water takes place naturally.

Using multiple component chemical programs can be very effective in the oil/water separation process. Coagulants can be utilized to break the emulsion, and if the floc size is not sufficient for removal, a secondary component such as a cationic, non-ionic, or anionic polymer could be fed into the solution. These polymers are available in both dry and liquid emulsion forms. There are some combination products that have both coagulation and flocculation properties without the need for polymer addition such as but not limited to the inorganics or the polyamines or DMDACC's which can have higher molecular weight properties. Many of the products utilized for this process have been designated as GRAS (Generally Recognized As Safe) which allows them to be utilized further down the line for additives in animal feed.

### 2. Mechanical Separation:

There are many mechanical separation techniques that may be suitable for use with the present disclosure. Centrifuges are one potential avenue for separation, however the power requirements may be such that an external power source may be required. This external power source could take the form of an on-board energy generation system mounted to the truck. Such an on-board system could be driven by the main engine of the truck in the form of a Power Take Off (PTO) or an enhanced electrical generator mounted to the engine. Alternative, there could be an independent on-board electrical generator driven by its own engine. As a further alternative, the truck could be equipped with a power input cord that is connected to the electrical service of the restaurant to provide the power needed to operate the centrifuge. A truck may also have a combination of these or other types of power sources to drive the centrifuge.

The utilization of air is an attractive alternative because of the ease of using the technology and it can be very effective in creating a very clean water source and a highly concentrated and distinct oil and grease layer. Air can be introduced and applied in many different ways, but the overall process generally utilizes induced, entrained, or dissolved air being injected into the oil/water mixture to separate the waste stream.

Induced air can be introduced in many ways as well including a pump, an air induction system, or cavitation. Induced air systems may be powered by similar power supplies as described above with regard to centrifuges.

Dissolved air can be introduced utilizing a separate air tube, a diffuser mechanism, a sincered tube, etc. Introducing compressed air may utilize air from the truck or a separately mounted air compressor, or air diffuser panel or air diffuser device. All of these types of dissolved or entrained air systems could have components either external or internal to the collection tank itself. The collection tank may include the existing chamber, or a separate chamber so that the oil/water mixture can be initially received on the truck in a first reservoir and treated before the concentrated oil and grease are added to the main storage reservoir. When utilizing a dissolved air system maintaining specific pressures are important so valving and gauges can be integrated to allow for the monitoring and adjustment of operational parameters if the air system to ensure the maximum efficiency of the air dissolving system. The air separation process can take place in the tank removing the waste material, or be completed in the oil/grease collection device that is currently onsite leaving the clean water in the vessel after the concentrated grease is removed by the grease removal truck.

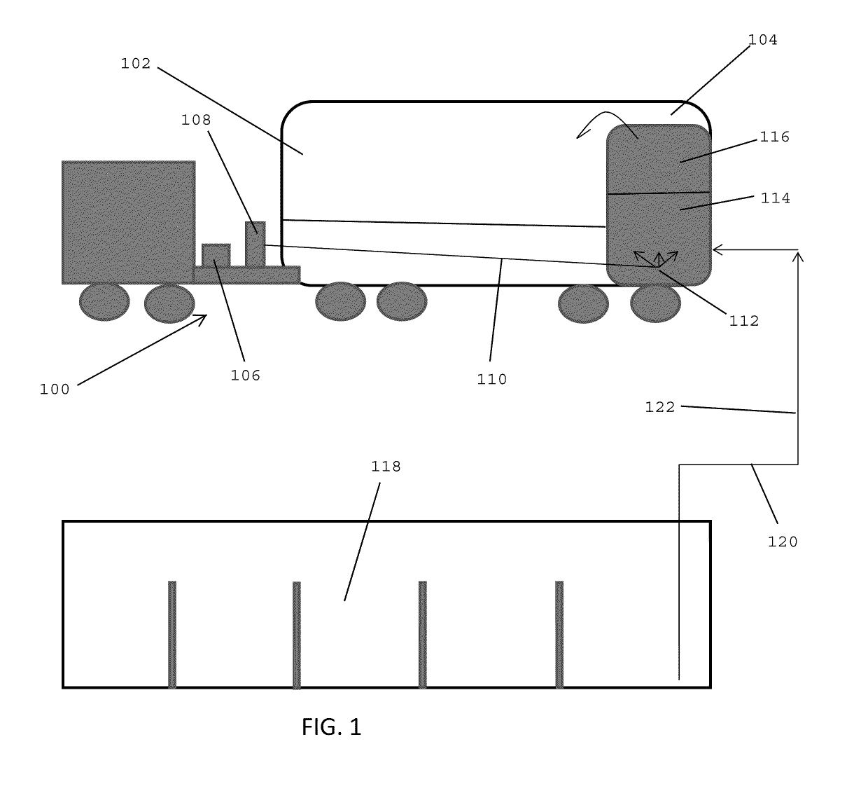

FIG. 1 illustrates a grease removal truck 100 according to the present disclosure, with a first main grease storage tank or chamber 102 and a second grease/water separation tank or chamber 104. A secondary power source or generator, or a power take off or other means of tapping power from the primary engine of truck 100 may be used to operate a compressor 106, which in turn provides a flow of air into an air tube 108. Air tube 108 may be connected into separation tank 104 by an air conduit 110. Conduit 110 may be operatively connected to an air injection head 112 mounted within or as part of separation tank 104. Air delivered from air tube 108 through conduit 110 and injection head 112 into a raw used cooking oil with a grease and water mixture collected from a holding tank 118 at a restaurant or other cooking oil using, generating, or collecting location. Any grease or water mixture within holding tank 118 may be collected through a conduit or other suitable collection pathway 120 and delivered to the separation tank within truck 100.

When sufficient amounts of the cooking oil have been collected within separation tank 104, air may be pumped through conduit 110 and injection head 112 within separation tank 104. Air rising through a mixture 114 of raw used cooking oil within tank 104 will tend to lift a more concentrated grease layer 116 to the top of mixture 104. Once enough grease 116 has risen to the top, it may spill over into the main grease collection tank 102. The remaining water (with some grease or oil still included), may be returned to the restaurant for disposal.

It is anticipated that it may be desirable to have one or more chemicals injected through a tap or other type of entry into conduit 120 and into the raw used cooking oil mixture as the mixture is being pumped from holding tank 118 into separation tank 104. Such injections may be routinely included as part of every used cooking oil collection. It is also anticipated that the injection of chemicals into conduit 120 for every collection used cooking oil collection location. Alternatively, the use of such chemicals may be targeted for a select few collection locations based on the type, amount and nature of the used cooking oil collected.

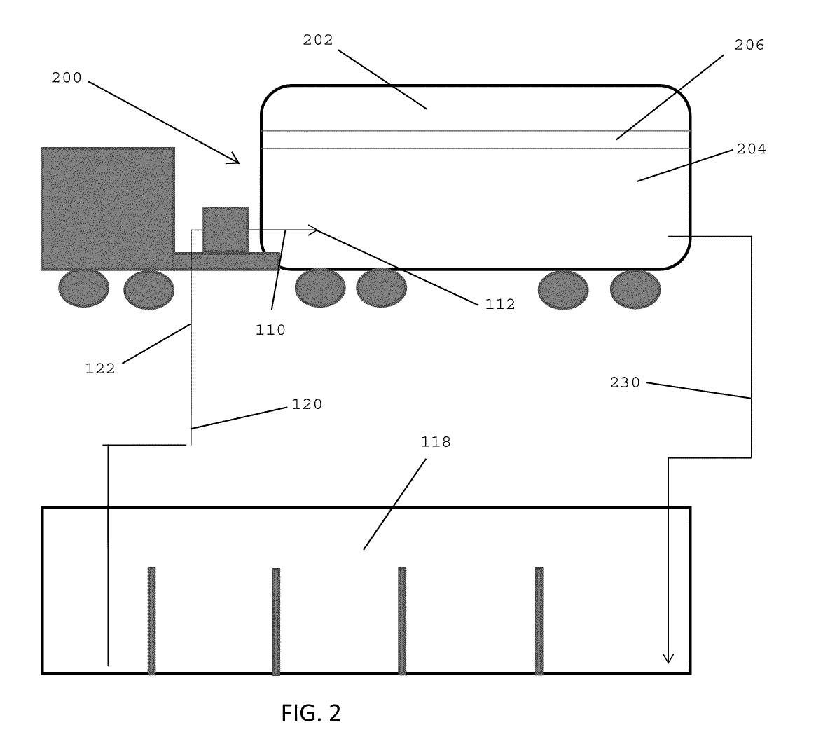

FIG. 2 illustrates an alternative embodiment of a grease collection truck 200 according to the present disclosure. Truck 200 is configured with a collection tank 202 into which raw used cooking oil from a restaurant holding tank 118 may be pumped through conduit 120 with chemical injection point 122. Truck 200 does not have a separate separation tank like truck 100, so the separation and holding of the concentrated grease 106 for transportation and removal occurs in the same tank. Once grease 106 has been separation from the raw mixture, the remaining water 104 may be returned or decanted into storage tank 108 for the restaurant or other facility to dispose of. As shown, the separation of grease from water in truck 20 may be accomplished primarily by chemical separation techniques, described but not limited to that described above. It is anticipated that air injection may also be used to accomplish the separation of grease and oil or that chemical and mechanical separation techniques may be used in conjunction with one another as needed.

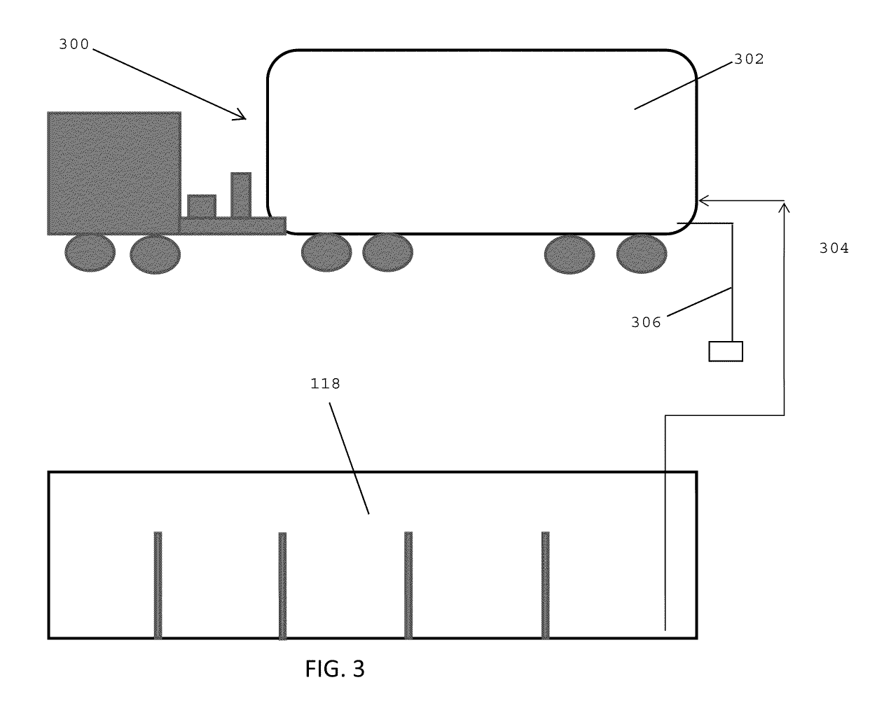

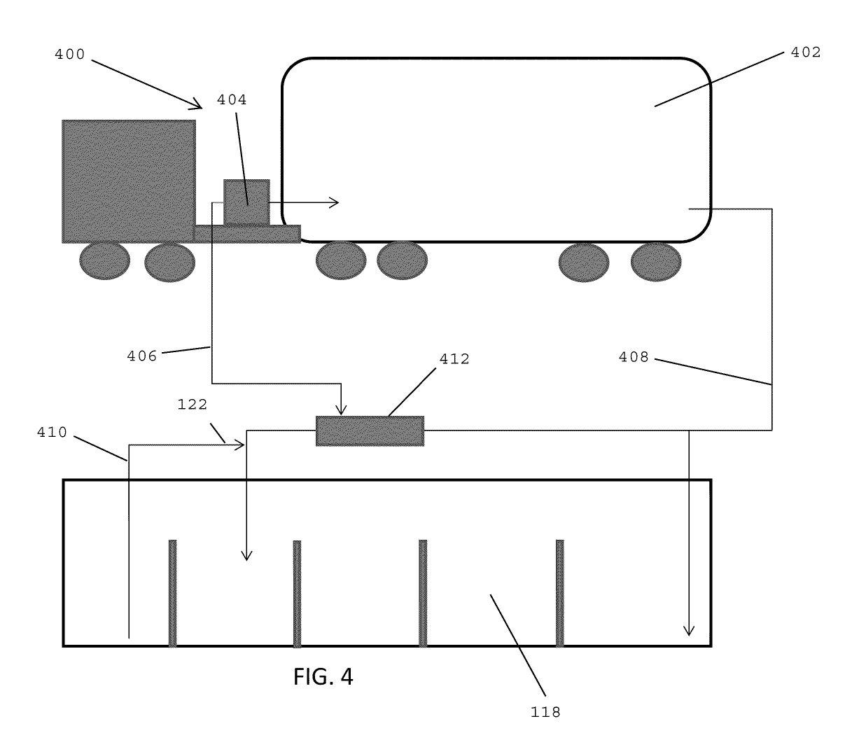

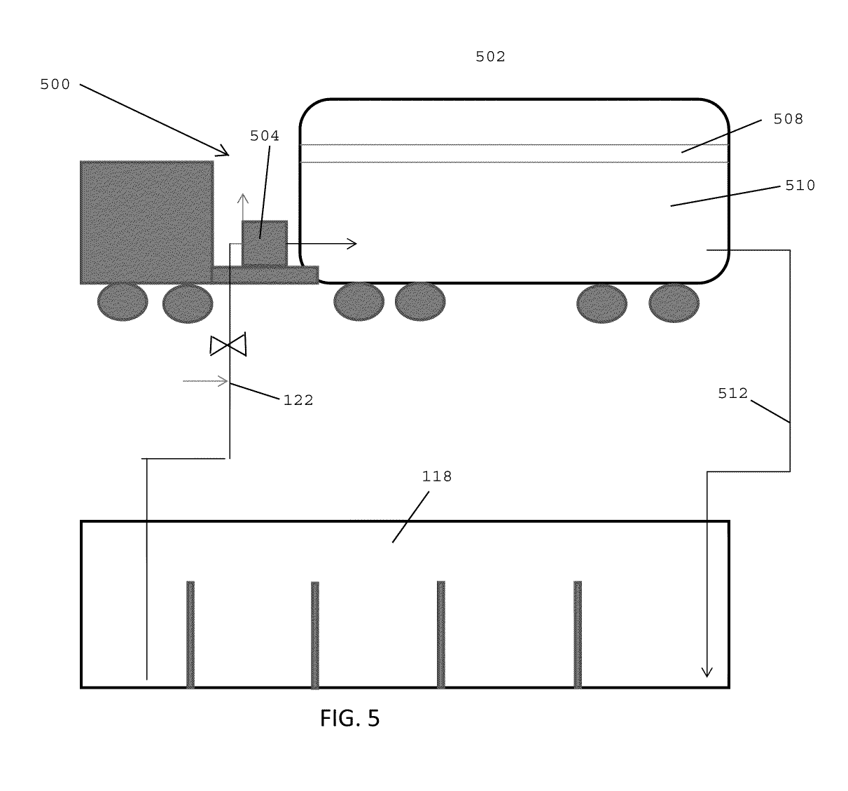

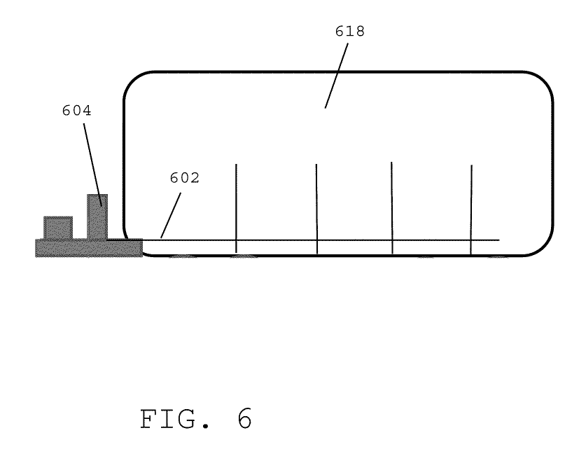

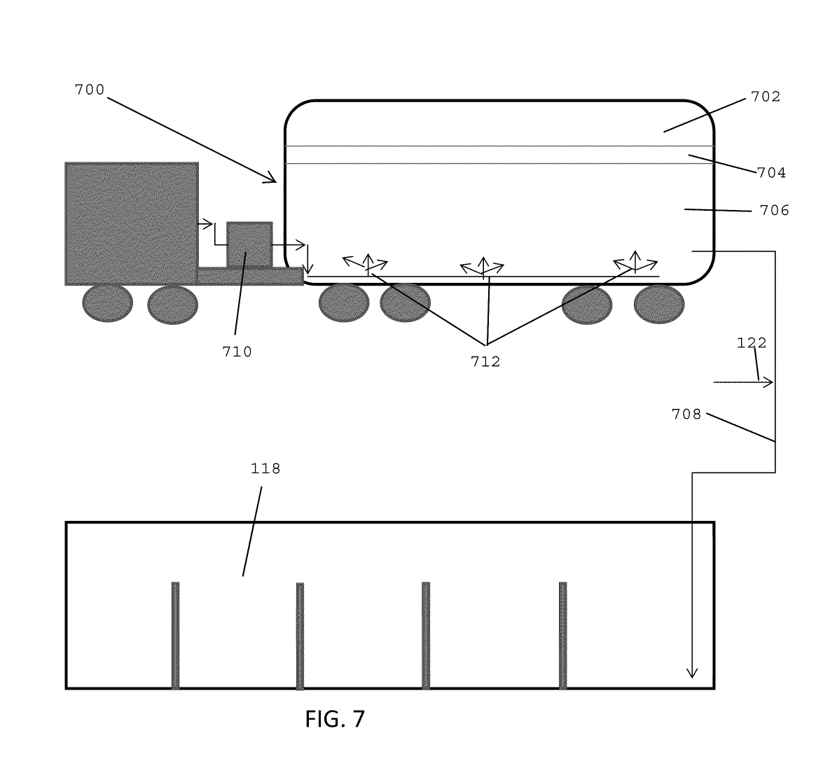

FIG. 3 illustrates a second alternative embodiment of a grease collection truck 300 according to the present disclosure, with a single collection tank 302 into which raw used cooking oil from a restaurant holding tank 118 my be pumped through a conduit 304. Chemicals to assist in the separation of the grease from the water within the used cooking oil may be injected into tank 302 through a separate conduit 306. Once the grease and water within the mixture have been separated, the water may be returned to restaurant tank 118 through conduit 304.

FIG. 4 illustrates a third alternative embodiment of a grease collection truck 400 according to the present disclosure. Truck 400 includes a single tank 402 for collection and separation of raw used cooking oil and for the storage and transportation of the accumulated grease from the separated used cooking oil. A conduit 408 is provided to permit used cooking oil to be pumped into tank 402 for processing and separation, and to return the excess water to tank 118 after separation.

Truck 400 also includes an air compressor 404, possibly driven by a Power Take Off from the primary drive engine of truck 400 that is connected by an air conduit 406 with oil conduit 408. Compressor 404 provides air that is then sent through an air entraining device 412 into the used cooking oil mixture in conduit 408 before the used cooking oil enters tank 402. The entrained air within the used cooking oil will assist in separating the grease from the excess water. The excess water may then be returned to the restaurant post separation permit easy disposal of the water. In addition, it is expected chemicals to assist separation, as described above, may be added to the used cooking oil at an injection point 122 prior to the used cooking oil entering tank 402.

FIG. 5 illustrates a fourth alternative embodiment of a grease collection truck 500 with a single grease collection and separation tank 502. A pump or air injection device 504 may be included in this embodiment to assist in the pumping of used cooking oil into tank 502 from tank 118 through a conduit 506. A chemical injection point 122 may be included in conduit 506. Pump 504 may also be used to inject air into the used cooking oil mixture within tank 502 to aid in the separation of grease 508 from water 510. A decant conduit 512 may be provided so that the water separated from the used cooking oil may be returned to restaurant tank 118.

FIG. 6 illustrates an alternative embodiment of a restaurant used cooking oil holding tank 618 according to the present disclosure. Tank 618 may be configured to provide the separation of grease and water in the used cooking oil produced by a restaurant so that the grease collection truck need not do any additional dewatering of the grease upon collection. The same technologies or techniques that are described above for use in a grease collection truck, such as using a compressor 604 to inject air into the tank, or the entraining of air into the used cooking oil as it moves through a conduit 602 into tank 618, and/or the injection of grease separation assisting chemicals into the used cooking oil, may be used in tank 618. This approach requires more equipment to be installed at the restaurant but would permit collection trucks that are simpler to operate and build to be used to collect the grease. The cost of the local separation system installed in tank 618 may be lessened by use of a package that is very similar configuration to the system used on one of the grease collection trucks described above.

FIG. 7 is a view of a further embodiment of a grease collection truck 700 according to the present disclosure with a single grease collection and separation tank 702. Within tank 702 may be mounted a plurality of air injectors 712 through which air from a compressor 710 may be injected into the tank to separate grease 704 from water 706. A conduit 708 between tank 702 and tank 118 permits the transfer of used cooking oil to tank 702 for separation and return of water from tank 702 to tank 118 after separation. Air injection to support separation of grease and water may be done as a continuous or steady stream of air or may be done by a plurality of bursts of air injected into the used cooking oil within tank 702. A chemical injection point 122 may also be included in conduit 708 to further assist or promote the separation of grease and oil within tank 702.

It is anticipated that combinations of any or all of the above embodiments may be made within the scope of the present disclosure, or that elements of any embodiment may be combined with elements or any other embodiment to promote and encourage the efficient separation of grease and water in used cooking oil before the used cooking oil is removed from the restaurant or other location for transportation to a grease handling or processing facility. It is not intended to limit the adoption or use of any of these elements based on the particular illustrative embodiment the element may be described within.

An initial configuration of a used cooking oil separation system and method may be to chemically separate the waste stream in the collection device, further concentrating the waste fats, oils, and grease by the use of chemical or air or the combination of both. In the situation where there is a large grease trap or used cooking oil collection tank, the chemical can be added to the tank prior to treatment to assist the separation process. Once the used cooking oil has been removed to a separation tank, a dissolved air system and or mixing can be administered to the used cooking oil within the tank to further separate the waste oil from the water. The initial design may include a sincered tube or diffuser which will deliver fine bubbles of oxygen to the water near the bottom of the separation vessel, greatly increasing the dissolved oxygen level within the used cooking oil. When the air injection unit is turned off, the oxygen will come out of solution creating fine bubbles that will lift and remove the contaminants from the waste stream causing the separation. A concentrated layer of grease will then float on top of the principally water component of the used cooking oil. The concentrated grease and oil layer then can be removed utilized a pump or vacuum device that skims or removes the separated layer from the waste stream leaving the clean water behind. Alternatively, a water removal outlet may be located low within the separation tank so that the water beneath the concentrated layer of grease may be removed, leaving the grease behind. Each restaurant or other used cooking oil collecting facility may then be required by their local municipality to vary the process and required concentration of grease removed based on the municipalities requirements for effluent water quality.

A secondary design for a grease removal system and method may be to either utilize chemical, air, or the combination of both during the process or post process of removing the used cooking oil from the collection device. As the used cooking oil is or prior to being removed from the holding tank, chemical and or air will be added to the conduit through which the used cooking oil is being transferred so that water/grease separation begins to take place sooner within the separation tank. Once the full separation takes place, the clean water can be decanted back into the restaurant holding tank so that only clean water acceptable to the particular municipal waste water treatment authority remains in the holding tank. The removal tanker or vessel can be utilized for the separation process (a single tank grease collection truck) or it can be performed with a separate vessel to finalize the treatment operation (separation of grease and oil within a separate separation tank and transportation of the concentrated grease is a second tank). The separation tank may be part of the grease collection vehicle or part of the used cooking oil holding tank. The devices and/or systems need to accomplish the separation may be mounted solely on the grease collection truck or may be mounted as part of the used cooking oil holding tank, or elements may be mounted locally while others are truck mounted. This process can take place onsite or at an alternate site if deemed more productive. If air is to be utilized during the separation process onsite, it can be performed in the collection device, inline in the removal tubing or equipment, or in the intermediate tank, or in the final removal tank itself. The key to this process is to chemically and or mechanically separate the undesired from the desired material prior to transportation so that disposal, transportation, and waste treatment costs are minimized. Any type of chemical and mechanical removal of the liquid/solids separation are covered under this application which is designed to minimize the amount of water and recoverable waste materials that are accumulated as part of the fats, oils, suspended solids, and grease removal from the restaurant and affiliated industries related to this type of waste removal.

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. Accordingly, the foregoing description is meant to be exemplary only, the invention is to be taken as including all reasonable equivalents to the subject matter of the invention, and should not limit the scope of the invention set forth in the following claims.

What is claimed is:

1. A waste oil collection system comprising:
a facility having a used cooking oil holding tank, the holding tank containing used cooking oil including grease and water combined;
a grease collection truck equipped to access the used cooking oil collection tank, the truck including a oil-grease separation device and a transportation reservoir;
the truck configured to receive the used cooking oil from the collection tank, separate at least a portion of the water from the grease of the used cooking oil to produce a concentrated grease portion and a removed water portion; the truck further configured to retain the concentrated grease mixture within the transportation reservoir and return the removed water portion to the facility.

2. The waste oil collection system of claim 1, further comprising a chemical injection point to add at least one chemical to the used cooking oil to aid in the separation of grease from water within the used cooking oil.

3. The waste oil collection system of claim 1, further comprising the oil-grease separation device includes an air injection assembly to inject air into the used cooking oil to aid in the separation of grease from water within the used cooking oil.

4. The waste oil collection system of claim 3, further comprising a chemical injection point to add chemicals to the used cooking oil to aid in the separation of grease from water within the used cooking oil.

5. The waste oil collection system of claim 2, wherein the at least one chemical is a flocculation promoting chemical to encourage separation of the grease from the water within the used cooking oil.

6. The waste oil collection system of claim 2, wherein the at least one chemical is a chemical operative to lower the pH of the used cooking oil to encourage the separation of the grease from the water within the used cooking oil.

7. The waste oil collection system of claim 3, wherein the air injection assembly is mounted to the grease collection truck and the air is injected into the used cooking oil within a tank of the truck.

8. The waste oil collection system of claim 1, wherein the grease collection truck includes a first separation tank and a second grease transportation tank.

9. The waste oil collection system of claim 3, wherein the air injection assembly is part of the holding tank.

10. The waste oil collection system of claim 3, further comprising the air injection assembly driven by an on-board generator separate from a primary engine of the truck.

11. The waste oil collection system of claim 3, further comprising the air injection assembly driven by a Power Take Off connection from a primary engine of the truck.

12. The waste oil collection system of claim 3, wherein the air injection assembly supplied air into the used cooking oil in bursts.

13. The waste oil collection system of claim 3, wherein the air injection assembly is configured to inject air into the used cooking oil as the used cooking oil is transported through a conduit from the holding tank to the grease collection truck.

14. The waste oil collection system of claim 2, wherein the chemicals are added to the used cooking oil as the used cooking oil is being transported through a conduit from the holding tank to the grease collection truck.

15. A method of collecting grease from used cooking oil, the method comprising:
providing a used cooking oil holding tank containing used cooking oil with a combination of grease and water;
providing a grease collection truck with a grease collection tank;
separating the grease from the water in the used cooking oil;
placing the grease in the grease collection tank, and the water in the holding.

16. The method of claim 15, further comprising separating the grease from the water in the used cooking oil on-board the grease collection truck and returning the water to the holding tank.

17. The method of claim 15, further comprising separating the grease from the water in the used cooking oil within the holding tank and moving the grease from the holding tank to the grease collection tank.

18. The method of claim 15, further comprising separating the grease from the water of the used cooking oil using chemicals.

19. The method of claim 15, further comprising separating the grease from the water of the used cooking oil using physical separation.

20. The method of claim 15, further comprising separating the grease from the water of the used cooking oil using a combination of physical separation and chemicals.
